(19) United States
(12) Patent Application Publication
(10) Pub. No.: US 2009/0253109 A1
(43) Pub. Date: Oct. 8, 2009

(54) Haptic Enabled Robotic Training System and Method

(76) Inventors: Mehran Anvari, Hamilton (CA); Kevin Tuer, Stratford (CA)

Correspondence Address: HODGSON RUSS LLP;THE GUARANTY BUILDING, 140 PEARL STREET, SUITE 100, BUFFALO, NY, 14202-4040, US

(21) Appl. No.: 12/297,892

(22) PCT Filed: Apr. 20, 2007
(86) PCT No.: PCT/CA07/00676

§ 371 Date: Mar. 13, 2009

Related U.S. Application Data
(60) Provisional application No. 60/793,641, filed on Apr. 21, 2006.

(51) Int. Cl. G09B 23/28

(52) U.S. Cl. 434/262

(57) ABSTRACT

A surgical training system comprising: a virtual environment including a virtual model of a surgical site; a trainer's haptic device for controlling a surgical tool in the virtual environment; a trainee's haptic device for controlling the surgical tool in the virtual environment, wherein the trainee's haptic device applies force feedback in dependence on signals received from the trainer's haptic device; and a controller for scaling the force feedback applied by the trainee's haptic device in dependence on a specified scaling value.

### RELATED APPLICATIONS

This application claims the benefit and priority of U.S. Provisional Application No. 60/793,641 filed Apr. 21, 2006, which is incorporated herein by reference.

### BACKGROUND

The need for training in laparoscopic surgery, surgical robotics and tele-robotics is growing incrementally with the acceptance and demand in this area of surgical practice. As laparoscopic surgery, robotic surgery and tele-surgery gains increasing utility and acceptance among the surgical world, training on this complex equipment is becoming of paramount importance. For example, the US Military has invested in development of a console-to-console robotic training capability through Intuitive Surgical. The prototype of this was successfully demonstrated at the American Telemedicine Association Conference in Denver in May of 2005. Currently this system allows the trainer to take over from the trainee as necessary or give the trainee the control of the slave arms at the patient's side. One disadvantage with the capability of current console-to-console robotic training systems is that control of the slave arms operated by the trainee appears to be on an all or nothing basis. Another disadvantage of current console-to-console robotic training systems is there is no ability to dynamically modify a virtual training environment of the trainee. Another difficulty is the latency that may occur between master and slave devices, especially when the devices are at remote locations.

### SUMMARY

According to example embodiments, aspects are provided that correspond to the claims appended hereto.

### BRIEF DESCRIPTION OF THE DRAWINGS

The following detailed description references the appended drawings by way of example only, wherein:

FIG. 1 is a block diagram of a telehaptic network system;

FIG. 2 is a block diagram of a computer for use in the system of FIG. 1;

FIG. 3 is an example trainer's user interface for manipulating of “no-go” zones in a haptic virtual environment for use in the system of FIG. 1;

FIG. 4 is an example trainer's user interface for manipulating of different anatomy views for use in the system of FIG. 1;

FIG. 5 shows an example trainer's menu user interface for use in the system of FIG. 1;

FIG. 6 shows an example trainer's user interface of a side view of a virtual torso;

FIG. 7 shows the trainer's user interface of FIG. 6, displaying a top view of the virtual torso;

FIG. 8a shows an illustrative Virtual Spring mechanism between trainee/trainer devices of FIG. 1;

FIG. 8b shows the Virtual Spring of FIG. 8a in a unilateral mode;

FIG. 8c shows the Virtual Spring of FIG. 8a in a bilateral mode;

FIG. 9 shows an example control system for the unilateral mode of FIG. 8b; and

FIG. 10 shows an example control system for a bilateral mode of FIG. 8c.

### DETAILED DESCRIPTION OF EXAMPLE EMBODIMENTS

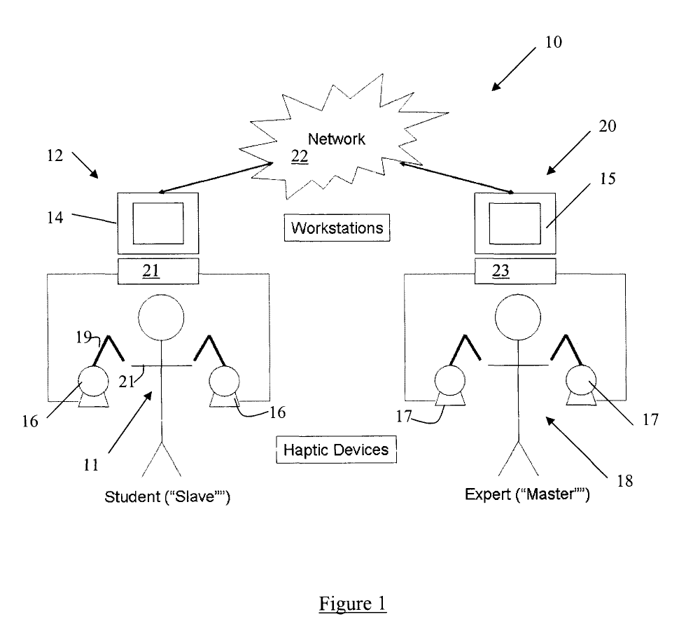

FIG. 1 illustrates an example embodiment of a haptic robotic training system 10. The system 10 facilitates the ability for a trainer 18 (e.g., an instructor, an expert, etc.) to dynamically modify the degree of operability/control of slave arms operated by a trainee 11 (e.g., student, intern, etc.), as well as facilitates the trainer 18 to dynamically modify a virtual training environment of the trainee 11. Applications of the system 10 include for example; training of surgical students, simulation of surgical procedures, and laparoscopic and robotic surgery augmented with haptic and visual information. Robotics/tele-robotics training using the system 10 facilitates a trainer 18 to limit the zone of activity of a trainee 11 incrementally allowing that zone to increase to its maximum as the trainee 11 gains experience. As well, the trainer 18 is able to limit the amount of force exerted by the trainee 11 on the tissue by the end effectors of haptic devices 16. In this manner the trainer 11 may limit potential injuries, which could occur if the trainee 11 accidentally, as a result of inexperience, exerted too much tension or force at the tissue level. In addition, interaction of the trainer 18 with the trainee 11 in a haptic tele-mentoring mode will facilitate the trainer 18 to lead the trainee 11 through training scenarios, thereby reinforcing the training content. All of these capabilities will facilitate the trainer 18 to create a monitored environment for the trainee 11 to gain experience as they embark on their first clinical cases, including situations where one trainer 18 can train multiple trainees simultaneously. It is herein recognised that a dynamic master/slave relationship between the trainer 18 and the trainee 11 respectively may be provided through configuration and operation of the corresponding workstation 20 coupled with the workstation 12.

Another feature is synchronization of the proprioceptive (or haptic) signals with the visual signals. A surgeon's brain is capable of adapting to discrepancy between proprioceptive and visual signals produced by the requirement to compress and decompress the video signals when sent over telecommunication networks up to a limit of around 200 ms. Synchronization of visual signals and proprioceptive signals during remote telerobotic surgery can allow a surgeon to perform tasks effectively and accurately at latencies of 200-750 ms. This capability is surgeon dependant and is also affected by level of experience. A trainee 11 may have less capability to adapt to such discrepancies between proprioceptive and visual signals then would a more experienced surgeon. As a result, in some example embodiments, it may be possible to synchronize the video and proprioceptive signals when working in a telesurgical environment.

Referring again to FIG. 1, the components of the system 10 include a trainee's workstation 12 comprised of a computer 14, trainee haptic devices 16 and a software application 21 for interfacing with the devices 16. The workstation 12 is connected to a trainer's workstation 20 via a network 22. The trainer's workstation 20 also comprises a computer 15, haptic devices 17 and a software application 23 for interacting with the trainer haptic devices 17. The software applications 21,23 may be configured for interactive communication with one another over the network 22 to facilitate adaptive control/coupling of the trainee haptic devices 16 through the trainer haptic devices 17, as further described below. Haptic devices 16, 17 can include, by way of example, hand activated controllers that provide touch feedback to the operator—an example of a haptic device is the PHANTOM OMNI™ device available from SensAble Technologies, Inc. of Woburn, Mass., U.S.A., however other haptic devices can also be used. In one example embodiment, each haptic device 16, 17 includes a stylus gimbal 19 that a user can manipulate with his or hand 21 to effect 3-dimesional movement of a surgical device in a virtual surgical environment. The stylus gimbal also places haptic force feedback on the user's hand. Network interfaces of the computers 14,15 provide for the two stations 12,20 to connect to one another to support tele-mentoring and interactive instruction for surgical procedures, as further described by example below in demonstration of the operation of the system 10. Accordingly, the two workstations—the trainee's workstation 12 and the trainer's workstation 20 are connected and are in communication via the network 22. As can be appreciated, the network 22 may include a direct wired or wireless connection, a local area network, a wide area network such as the Internet, a wireless wide area packet data network, a voice and data network, a public switched telephone network, a wireless local area network (WLAN), or other networks or combinations of the forgoing. As shown, each workstation 12, 20 is comprised of a computer 14, 15 on which is deployed a virtual surgical environment and the haptic devices 16, 17 that emulate laparoscopic tools, for example. In some example embodiments, the trainer 18 will be able to monitor the trainee's 11 progress remotely and telementor at will.

In some example embodiments, the software applications 21,23, can be developed using known haptic application development tools such as proSENSE™, which is available from Handshake VR Inc. of Waterloo, Ontario Canada. Software applications 21,23 are comprised of code that controls the haptic devices 16,17, controls the interaction between the trainer 18 and trainee 11 and the virtual realty environment, controls the interaction between the trainer 18 and trainee 11 in telementoring mode, and controls the virtual environment itself. Generally, the software 21,23 may be used to facilitate configuration of the robotic training system 10 to implement training in a gradual manner through adaptive control of the trainee haptic devices 16 by the trainer haptic devices 17. The software includes embedding haptic capabilities into the surgical robotic training system 10 and to provide the trainer 18 with the ability to interactively limit a zone of surgical activity (i.e. creation of “no-go” zones) of the trainee and the ability to limit the amount of force exerted by the trainee 11 on the tissue by the end effectors of the trainee haptic devices 16 to for example facilitate desired surgical outcomes. In some example embodiments, the software 21,23 assists the workstation 12,20 operators to create a haptically enabled robotic training system 10, incorporate haptic “no-go” zones into the robotic training system 10, incorporate a gradable force capability into the robotic training system 10, conduct performance trials, and investigate methods to synchronize the visual and haptic modalities. Generally, as an example, the software applications 21,23 and coupled devices 16,17 are dynamically configurable to adaptively limit the zone of surgical activity of the trainee 11, limit the amount of force exerted by the trainee 11, and enable trainer/trainee telementoring. Further, the trainee 11 may gain valuable training experience in a non-threatening training environment with the added benefit of real time haptic interaction with the trainer 18. For example, the training system 10 may be used to train surgeons on robotic/tele-robotic surgical presence on the battlefield or remote regions.

In some example embodiments, the software applications 21,23 generally can be used to provide the trainer 18 with dynamic configuration capability during surgical procedures or other training scenarios to implement:

a) inclusion of haptic “no-go” zones within a surgical site will facilitate that the surgical tools do not come into contact with non-surgical organs within the surgical site. More specifically, it is possible to place virtual walls or surfaces (i.e. a haptic cocoon) around non-surgical anatomy such that when the trainee moves the surgical tools near or into the “no-go” zone, a haptic effect will be invoked to effectively offer resistance to the surgical tool and prevent the tool from coming into contact with the anatomy. The haptic feedback will serve to reinforce both the desired and undesired movements of the surgical instruments. The spatial extent of the “no-go” zones (and number thereof) in the environment 100 are dynamically configurable by the trainer 18 through a user interface as the experience of the trainee 11 progresses;

b) providing a trainer 18 with the ability to scale the amount of haptic feedback provided within the surgical site will allow the trainer 18 to tailor the teaching experience to the individual capabilities of the trainee 11. As a result, it is hypothesized that individualization or customization of the training characteristics will result in trainees grasping surgical techniques more efficiently (e.g. time to complete a task); and/or

c) providing the trainer 18 with the ability to telementor the trainee 11 with the sense of touch which will solidify training concepts and can make the training process more time efficient.

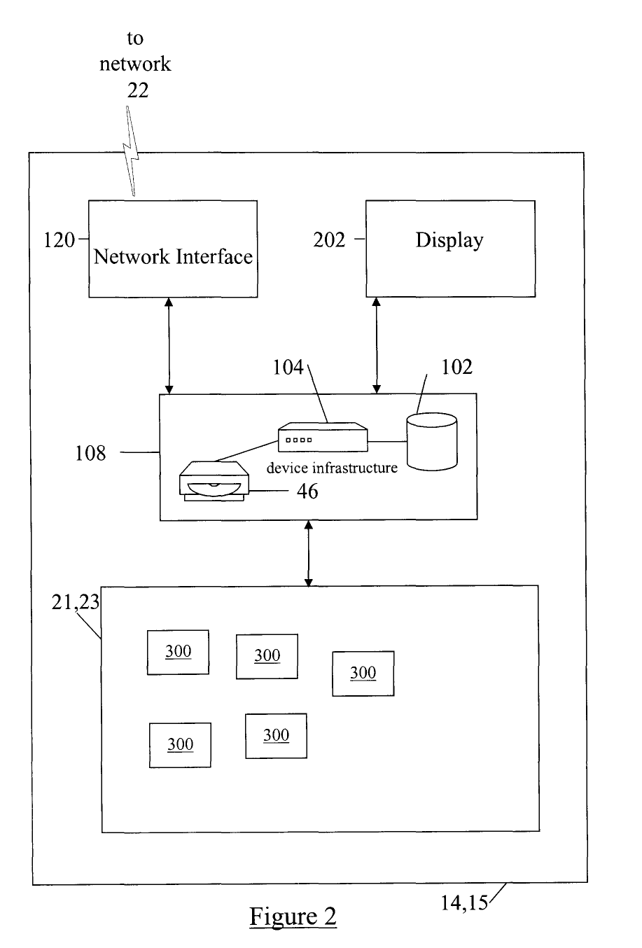

Referring now to FIG. 2, the computers 14,15 provide for visualization of the virtual haptic environment, as displayed on a visual interface 202 (for example, a display screen). The computers 14,15 generate an interactive visual representation of the haptic environment on the display 202, such that the environment seen by the trainee 11 is synchronous with the environment seen by the trainer 18. The computer 14, 15 are configured to communicate over the network 22 via a network interface 120, for example a network card. The computers 14,15 each have device infrastructure 108 for interacting with the respective software application 21,23, the device infrastructure 108 being coupled to a memory 102. The device infrastructure 108 is also coupled to a controller such as a processor 104 to interact with user events to monitor or otherwise instruct the operation of the respective software application 21,23 and monitor operation of the haptic devices 16,17 via an operating system. The device infrastructure 108 can include one or more user input devices such as but not limited to a QWERTY keyboard, a keypad, a trackwheel, a stylus, a mouse, and a microphone. If the display 202 is a touch-screen, then the display 202 may also be used as a user input device in the device infrastructure 108. The network interface 120 provides for bidirectional communication over the network 22 between the workstations 12,20. Further, it is recognized that the computers 14,15 can include a computer readable storage medium 46 coupled to the processor 104 for providing instructions to the processor 104 and/or the software application 21,23. The computer readable medium 46 can include hardware and/or software such as, by way of example only, magnetic disks, magnetic tape, optically readable medium such as CD/DVD ROMS, and memory cards. In each case, the computer readable medium 46 may take the form of a small disk, floppy diskette, cassette, hard disk drive, solid-state memory card, or RAM provided in the memory 102. It can be appreciated that the above listed example computer readable mediums 46 can be used either alone or in combination.

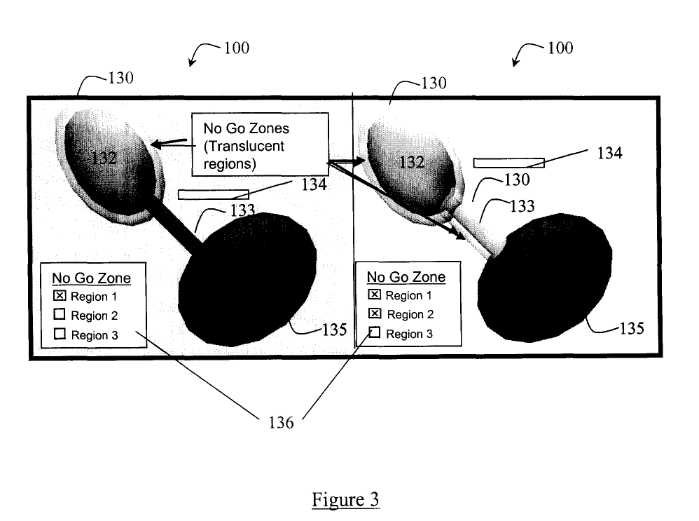

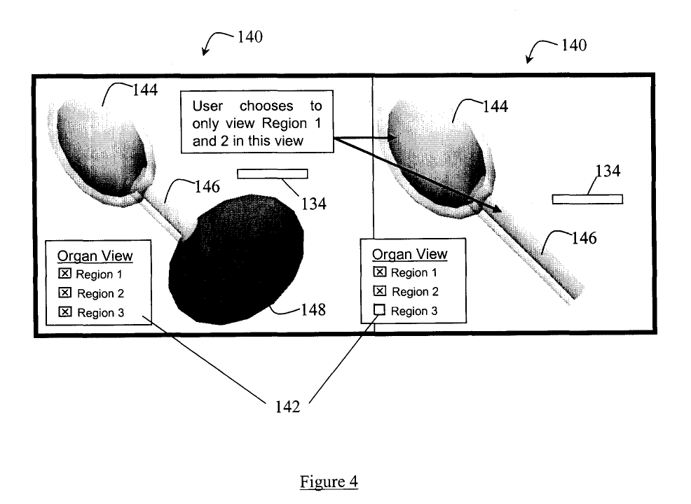

Reference is now made to FIGS. 3 and 4, wherein FIG. 3 shows a trainer's virtual environment user interface 100 shown on the display 202 for controlling “no-go” zones, and FIG. 4 shows a trainer's virtual environment user interface 140 for controlling the viewing of different anatomical regions. Generally, if a “no-go” zone is disabled, haptics may be utilized to emulate the feel of an actual organ when in contact with a surgical tool. If a “no-go” zone is enabled, the surgical tool will not be permitted to enter the particular region. Through a menu driven system of the software 23, the trainer 18 is able to enable/disable zones as well as add/remove the organs from the virtual world represented by virtual environment user interface 100. As can be appreciated, any organs in a virtual environment may be graphically and haptically rendered, and may optionally be animated.

Referring again to FIG. 3, the trainer's virtual environment user interface 100 is shown on the display 202, and is comprised of a model of the abdominal cavity and associated organs/arteries, consisting of different regions:

Region1 132, Region2 133, and Region3 135. “No-go” zones 130 are shown around the organs and arteries and are illustrated as translucent regions. A virtual surgical tool 134 is also shown. In a “no-go” case, a protective haptic layer prevents the surgical tool 134 from coming in contact with the virtual organs/arteries. It is also recognised that the “no-go” zones 130 can be used to hinder but not necessarily prevent contact with the regions 132, 133, and 135 (e.g. “with resistance go-zones”), hence to be used more as a warning indicator for certain prescribed regions of the environment, as will be explained in greater detail below. Further, audible and/or visual alarm indicators can be presented to the user of the station 12, 20 through a speaker (not shown) and/or through the display 202 when the “no-go” zones 130 are encountered. In operation, a user (e.g., trainer 18) uses the menu box 136 to toggle or configure the “no-go” zones. The image on the left shows the case where the “no-go” zone has been turned on in Region1 132, while the “no-go” zone has been turned off in Region2 133 and Region3 135. The image on the right shows the case where the “no-go” zones have been turned on in Region1 132 and Region2 133, and turned off in Region3 135. Forces will be rendered such that the tip position of the haptic device 16,17 will not be permitted to enter the translucent region of the “no-go” zones 130, and similarly a tip of the virtual surgical tool 134 would not be permitted to enter the “no-go” zones 130. The strength of the repelling force may be scaleable or tuneable, as will be explained in greater detail below. As explained in greater detail below in at least some example embodiments, the trainer mentor is able to control the force applied by the student on the surgical instrument.

Referring now to FIG. 4, the trainer user interface 140 shows an organ having different regions: Region1 144, Region2 146, and Region3 148. Also shown is a menu box 142 which may be used to toggle or configure which regions are to be viewed. Accordingly, a user will also be able to add/remove organs 132 from the virtual environment. The regions that are viewed will be haptically rendered such that they will feel compliant. In other words, the user will be able to press into the region and feel the anatomy corresponding to the particular viewed regions. The regions that have the viewing disabled would allow free passage of a virtual surgical tool.

In some example embodiments, the stiffness and surface friction will be scaleable or tuneable as well as made “deformable”, as desired. In addition, the software applications 21,23 can be used to permit dynamic modification of the “no-go” zones such that: the trainer 18 can effectively limit the “free” zone in which a trainee can manoeuvre the robotic instruments; the “no-go” zone be incrementally reduced/enlarged; a “no-go” zone be quickly & effectively constructed around a specific organ or anatomical structure; control of force exerted by robotic instruments can be moderated; a trainer 18 can effectively dial up or down the amount of force exerted by the trainee with the robotic instruments in grasping or pushing the tissues during robotic surgery; and synchronization of visual and proprioceptive signals are used to increase the range of latency within which a surgeon can perform safe and effective tele-robotic tasks. It is recognised that the trainer can use the software application 23 to effect dynamic changes to the operating parameters of the workstation 12 and more specifically the operation of the devices 16 and the information displayed to the trainee on the display 202 of the workstation 12.

In an example embodiment, the trainer's virtual environment user interface 100 can be created using a VRML (Virtual Reality Modeling Language) format. The advantages to using VRML include: standardized format; repository of existing VRML objects; supports web deployment; and VRML format can be extended to include haptic properties. A MATLAB™ development environment also contains tools that may facilitate the creation of GUI's (graphical user interfaces).

Referring again to FIG. 2, the software application 21,23 can have a plurality of modules 300 for coordinating operation of the system 10, the modules 300 having functionality such as but not limited to:
training laparoscopic and robotic surgery;
use of haptic (force feedback) devices, scalable force feedback, and a virtual environment to simulate laparoscopic and robotic surgery procedures;
a telementoring capability to allow an instructor to interact with the student using a full set of modalities (i.e. sight, sound and touch);
a latency management system to maximise stability and transparency of the telehaptic interactions;
a virtual environment that contains a virtual model of the surgical site;
haptic information is embedded in the virtual environment to assist in the procedure (e.g. haptic barriers around organs/anatomy that are not to come in contact with the surgical instruments);
a user interface that allows the instructor to control the characteristics of the student's simulator environment;
a capability to integrate the operation of a surgical robot into the simulated environment in a synchronized fashion;
an ability to use the haptic devices to alter the location and orientation of a number of different simulated surgical tools (e.g. scalpel, camera, sutures);
an ability to create or define the surgical site and associated haptic effects interactively in a graphical environment;
an ability to simulate the haptic, visual and audio interaction of the virtual surgical tools with the simulated anatomy;
an ability to include motion of virtual anatomy (e.g. beating heart) in the simulation;
an ability to measure the motion of anatomy from an actual surgical site and create virtual models of their counterparts with full animation;
an ability to measure, quantify and assess human performance in completing a task;
an ability to synchronise haptic interactions, visual data, and events;
an ability to use the training system locally or remotely; use of haptic enabled “no-go” zones to prevent/hinder unintentional contact with organs, tissue, and anatomy;
provides the trainee with the ability to train locally or remotely in a VR environment with the sense of touch;
scalable force feedback component that simulates the force interaction between the robotic tools and the surgical environment that can be set and altered by the user;
built in tele-mentoring capability to allow a student to be mentored locally or remotely over a network connection by an expert visually, audibly and haptically;
built in tele-mentoring capability that allows one trainer to mentor multiple trainees simultaneously using the full set of modalities (sight, sound and touch), such that the trainer can train multiple trainees sequentially one at a time during a training session or more that one trainee at a time simultaneously in the same virtual environment;
full simulation environment that can augment a robotic surgery system with haptic cues and information; and
a training system to monitor individual performance, for example the MATLAB™ environment is suited for collecting data and scripting analytical routines to assess performance levels.

The above mentioned Handshake VR Inc's proSENSE™ tool and in particular the proSENSE™ Virtual Touch Toolbox is one example of a tool that can be utilized to develop the software applications 21,23. The Handshake proSENSE™ Virtual Touch Toolbox is a rapid prototyping development tool for creating sense-of-touch (a.k.a. haptic) and touch-over-network protocol (a.k.a. telehaptic) applications. Handshake proSENSE™'s graphical programming environment is built on top of The MathWorks MATLAB® and Simulink® development platform. The easy-to-use, drag-and-drop environment allows novice users to quickly develop and test designs while being sufficiently sophisticated to provide the expert user with an environment for application development and deployment of new haptic techniques and methodologies. The system 10 uses integration of haptics and the virtual reality environment 100. To this end, the current version of Handshake proSENSE™ supports Virtual Reality Modeling Language (VRML) based graphical environments and the MathWorks Real-Time Workshop® to compile the resulting application into real time code. The current proSENSE™ platform can be used to compile a virtual reality environment created using the VR Toolbox into stand-alone code, including the features of:
extension of the VRML format to include “haptic” nodes. This allows graphical objects to have haptic properties;
mesh support to allow the creation of more complex graphical and haptic objects; and
a hapto-visual design environment that provides for the ability to compile the entire application, including graphical objects, into a stand-alone application that does not require MATLAB or any of its components to run.

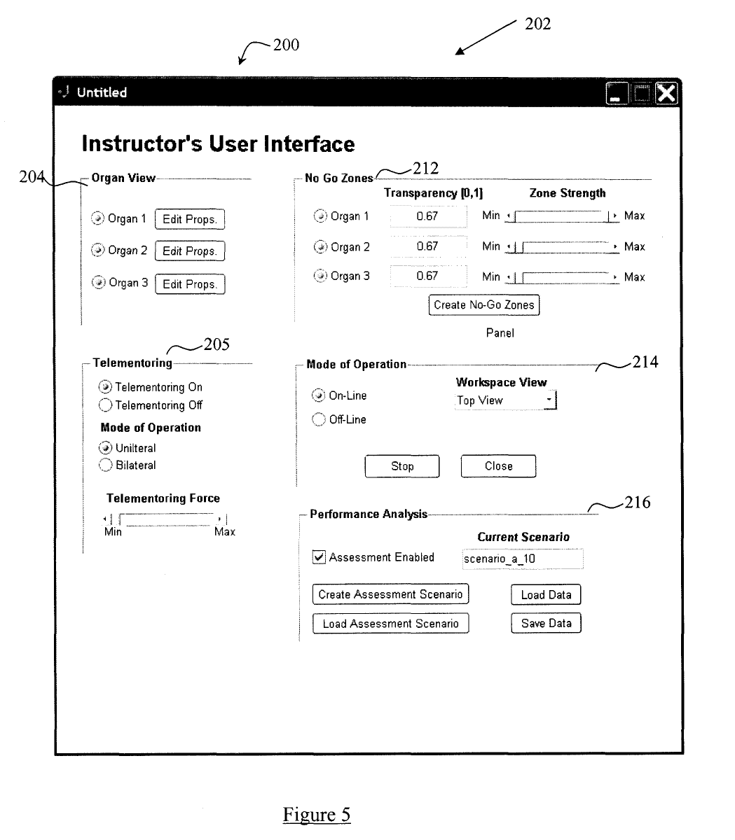

Reference is now made to FIG. 5, which shows an example trainer's menu user interface 200 shown on the display 202 for use in the system 10 of FIG. 1. This may for example be used by the instructor or trainer 18 to configure a virtual reality environment, for example using the trainer workstation 20. As shown, there are a number of sub-menus or panels for configuration of the virtual environment by the trainer 18. These panels include Organ View panel 204, No-Go zones panel 212, Telementoring panel 205, Modes of Operation panel 214, and Performance Analysis panel 216.

The Organ View panel 204 allows the trainer 18 to select the organs that are to be visible during the training event. Using the “Edit Props.” Button (short form for “Edit Properties”), the haptic and visual properties of the object may be modified.

The No-go Zones panel 212 allows the trainer 18 to select which “no-go” zones are to be active. In the case above (for example the regions in FIG. 3), there is one “no-go” zone associated with each organ. The trainer 18 is also able to set the properties of the “no-go” zones on an individual basis. In the case presented above, the trainer 18 may use the “Zone Strength” Minimum Maximum sliding scales 213 to set the transparency or translucency of each of the respective the “no-go” zones as well as the level of resistance offered by the respective “no-go” zone to penetration by haptic device (e.g., the trainee haptic devices 16 and the trainer haptic devices 17). By pushing the “create No-Go Zones” button, the trainer 18 is able to define custom “no-go” zone locations, shapes, etc.

The Telementoring panel 205 allows the trainer 18 to set the tele-mentoring characteristics (i.e. the type of mentoring interaction with the student) of the simulation such as: turning tele-mentoring on or off; selecting the mode of interaction to be unilateral (the mentoring force of the instructor is felt by the student) with zero/negligible feedback felt by the trainer 18, or bilateral (the mentoring force of the instructor is felt by trainee 11 and the trainer 18 can feel the motion of the trainee 11) that the motion of the trainee haptic devices 17 is influenced by a degree (scaleable from 0% up to 100%, where 1000% represents total control) by the motion of the trainer haptic devices 16; and the amount of tele-mentoring force exerted. These features will be explained in greater detail below.

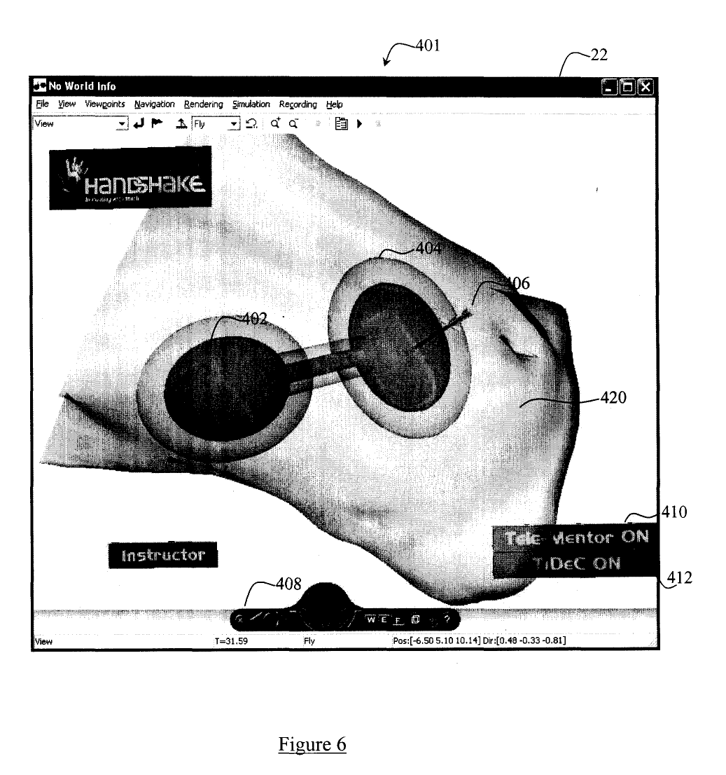

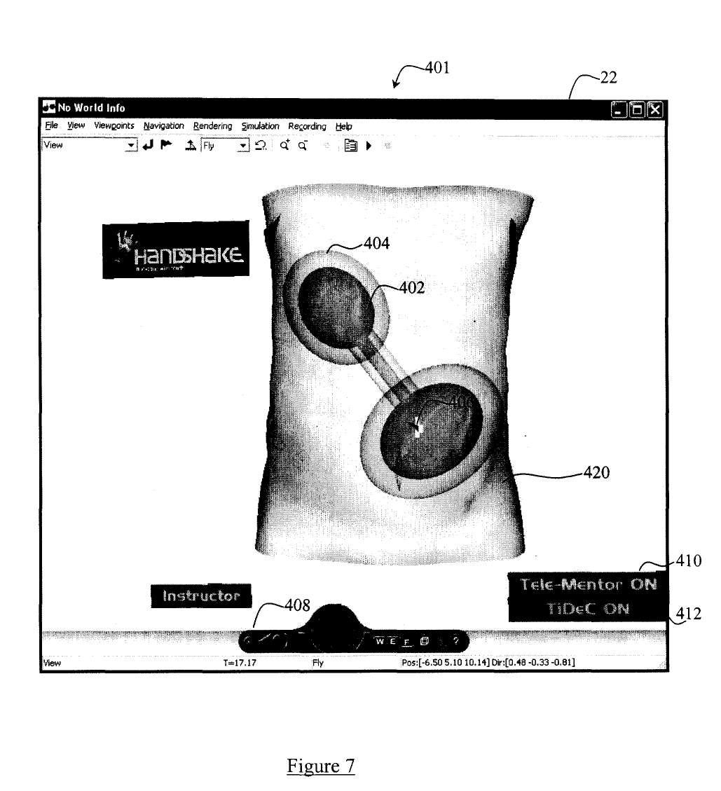

The Mode of Operation panel 214 allows the trainer 18 to set the overall characteristics of the simulation environment. For instance: if On-Line is selected, the trainer 18 and trainee 11 environments are connected (e.g. conducting a training session); if Off-Line is selected, the trainer 18 and trainee 11 environments are not connected (e.g. the trainer 18 is setting up a training scenario or the trainee 11 is training independently); the Stop button disables the animation of the simulation; the Close button closes the entire simulation program; and the Work Space View pull down allows the trainer 18 to select the view angle of the virtual model. The different view angles will be explained in greater detail below with reference to FIGS. 6 and 7.

The Performance Analysis panel 216 allows the trainer 18 to establish and control the assessment mechanism for the trainee 11. For instance: enabling or disabling assessment; creating a new assessment regime; load a predefined assessment regime; loading and displaying stored assessment data; and saving current assessment data to file.

A telementoring mode will now be discussed in greater detail. The telementoring mode may be enabled by for example by using the Telementoring panel 205 (FIG. 5). In an example embodiment, the telementoring capabilities are created using Handshake VR Inc's proSENSE™ Virtual Touch Toolbox and its integrated latency management tool called TiDeC™, which can be used to provide an environment in which the trainer 18 has the ability to take control of the trainee's 11 surgical tools/devices and environment, all with the sense of touch, to provide the trainee 11 with on the spot expert instruction with a full set of modalities. The telementoring mode can be best described as placing a virtual spring between the tip position of the local haptic devices and the associated remote haptic devices. This way, as one user moves their device, the second user will feel the forces generated by the first user. Moreover, the telementoring mode can operate in a unilateral mode or a bilateral mode. In the unilateral mode, the trainer 18 will not feel the forces generated by the trainee 11, but the trainee 11 user will feel forces generated by the trainer 18. In the bilateral mode, both trainer 18 and trainee 11 will feel the forces generated by the other user. The telementoring mode may be used for example when the trainer's workstation 18 is remote from the trainee's workstation 12.

The ability for two or more users to interact, in real time, over a network with the sense of touch (i.e. telehaptics) is in some environments sensitive to network latency or time delay. As little as 50 msecs of latency can lead to unstable telehaptic interactions. Thus, in at least some example embodiments, time delay compensation technology is used to enable telehaptic interactions in the presence of time delay. By way of example, Handshake VR Inc. offers a commercially available time delay compensation technology, called TiDeC™, that can be used to enable telehaptic interactions in the presence of time delay. Handshake VR Inc. indicates that TiDeC™ is able to compensate for time varying delays of up to 600 msecs (return) and 30% packet loss for example.

Haptic telementoring is a method by which one individual can mentor another individual over a network connection with the sense of touch. In the context of training laparoscopic surgery techniques, for example, consider the example system 10 (FIG. 1). The workstations 12, 20 are connected via a network 22. Using haptic telementoring, a trainer 18 is able to control the movement of the trainee's haptic devices 16 in real time in such a fashion as to train the trainee a surgical method or technique.

The haptic interaction between the trainer 18 and the trainee 11 has various modes, which may for example be configured using the Telementoring panel 205 (FIG. 5):
No interaction. The trainee 11 and trainer 18 work within the shared virtual environment independent of the other.
Unilateral mode. The trainer 18 takes control of the trainee's haptic devices 16 in a master/slave fashion to a specified degree (from 0% up to 100%). The trainee 11 is able to feel the force input of the trainer 18 but the trainer 18 is not able to feel the resistance to movement that may be offered by the trainee 11.
Bilateral mode. Both the trainer 18 and the trainee 11 can feel the motion of the other's haptic devices 16, 17 such as would be the case in a game of tug of war.

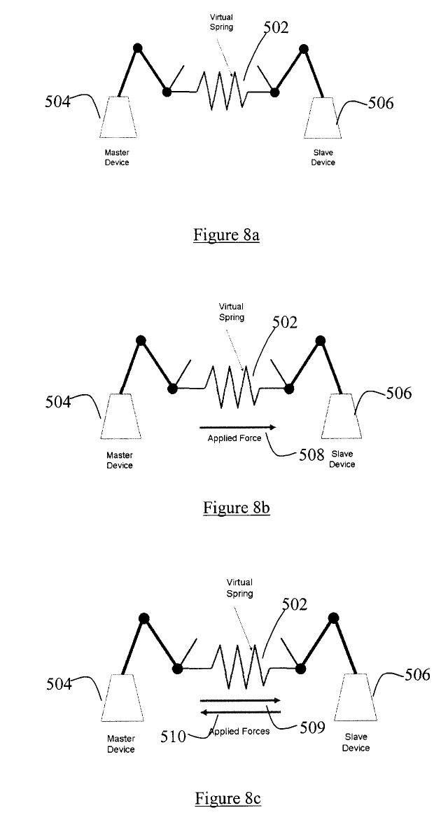

For example, referring now to FIG. 8a, consider a virtual spring 502 or other representative variable force coupling mechanism connected between the tips of a trainer's device 504 (master) and a trainee's device 506 (slave). In a unilateral mode of operation, even though the two devices are slaved together, the virtual spring 502 only exerts a force on the trainee's device 506 (this is not physically realizable, only in conjecture), while no force is exerted back to the trainer. As shown in FIG. 8b, an applied force 508 is only applied in one direction. In a bilateral mode of operation, the virtual spring 502 is able to exert a force in both directions, similar to a real spring. As shown in FIG. 8c, an applied force 509 is applied from the trainer's device 504 to the trainee's device 506, and an applied force 510 is applied back from the trainee's device 506 to the trainer's device 504. Trainer's device 504 can for example be the haptic device 17, and the Trainee's device 506 can for example be the haptic device 16.

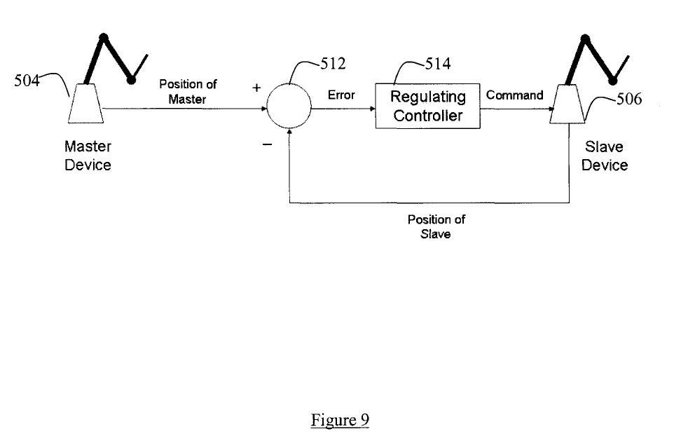

It is recognised that the virtual spring 502 effect which creates the unilateral and bilateral modes of operation can be implemented by the transmission of device position data and a regulating control scheme. Reference is now made to FIG. 9, which shows a unilateral mode of operation between the trainer's device 504 and the trainee's device 506. The position of the trainer's device 504 is transmitted to the computer that controls the trainee's device 506. Within the computer of the trainee's device 506, a feedback controller is implemented to slave the position of the trainee's device 506 to the trainer's device 504. This may for example be implemented by a negative feedback loop, using an error module 512 that calculates a difference between the position of the trainee's device 506 and the position of the trainer's device 504. The reference signal to the controller 514 is the position of the trainer's device 504. The position of the trainee's device 506 is also fed back to the controller. The controller 514 creates a command signal that strives to minimize the difference between the position of the trainer's device 504 and the slave device 506 (the “error”). The controller 514 applies a control signal to the trainee's device 506. Thus, the larger the error, the larger the force felt by the trainee's device 506. Accordingly, in this unilateral mode of operation, no information regarding the position of the trainee's device 506 is fed back to the trainer's device 504.

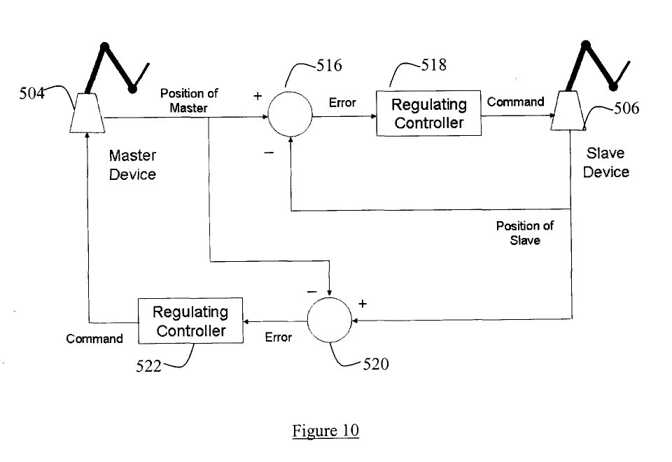

Reference is now made to FIG. 10, which shows a bilateral mode of operation. In contrast to the unilateral mode of FIG. 9, information regarding the position of the trainee's device 506 is fed back to the trainer's device 504. As shown, on the side of the trainee's device 506, the error module 516 and the controller 518 operate in a similar manner as described above. On the side of the trainer's device 504 is shown another regulating controller 522 and error module 520, which operates in a similar fashion to that of the side of the trainee's device 506, and uses the position of the trainee's device 506 as the reference for the controller 522. The controller's 522 function is to minimize the error between the position of the trainer's device 504 and the trainee's device 506 through a command sent to the trainer's device 504. Because there is a corrective error module 516,520 and controller 518, 520 on both sides, both devices 504,506 exert respective compensatory forces on the corresponding user.

An example operation of the system 10 is now explained with reference to FIGS. 6 and 7, wherein FIG. 6 shows an example trainer's user interface 401 of a side view of a virtual torso 420, and FIG. 7 shows a top view of the virtual torso 420. The trainee's user interface would mirror the trainer's user interface 401, with additional or less features displayed on the user interface, as appropriate. As shown, a “tele-mentor” indicator 410 may be used to indicate that telementoring is enabled. Telementoring may for example be enabled by using the Telementoring panel 205 (FIG. 5). As shown in FIGS. 6 and 7, the torso may be overlaid onto a simulated or virtual environment. An organ 402 is shown having “no-go” zones 404, as indicated by translucent regions. A virtual laparoscopic tool 406 is also shown as a needle-like object. As can be appreciated, the position and orientation of the laparoscopic tool 406 may for example be controlled by the haptic devices 16,17 of FIG. 1. As explained above, the “no-go” zones 404 may be used to partially or fully prevent contact with the regions as indicated. A time delay compensation indicator 412 is also shown to indicate that software (implemented for example using TiDeC) is compensating for any network latency, as explained above.

The display of the virtual torso between the side view (FIG. 6) and the top view (FIG. 7) may be effected by using the tool bar 408, which may provide 360 degree freedom in viewing. The particular view may also be selected by the Modes of Operation panel 214 (FIG. 5), as discussed above. The above-described embodiments of the present application are intended to be examples only. Alterations, modifications and variations may be effected to the particular embodiments by those skilled in the art without departing from the scope of the application, which is defined by the claims appended hereto.

1. A surgical training system comprising:
a virtual environment including a virtual model of a surgical site;
a trainer's haptic device for controlling a surgical tool in the virtual environment;
a trainee's haptic device for controlling the surgical tool in the virtual environment, wherein the trainee's haptic device applies force feedback in dependence on signals received from the trainer's haptic device; and
a controller for scaling the force feedback applied by the trainee's haptic device in dependence on a specified scaling value.

2. The surgical training system of claim 1 wherein the specified scaling value falls within a range of 0% to 100% of a force applied at the trainer's haptic device.

3. The surgical training system of claim 1 including a trainer's station associated with the trainer's haptic device, the trainer's station including an interface through which a trainer can input a value for use as the specified scaling value.

4. The surgical training system of claim 1 wherein the trainer's haptic device applies force feedback in dependence on signals received from the trainee's haptic device.

5. The surgical training system of claim 1 wherein the training system is a telehaptic training system in which the trainer's haptic device is at a location remote from a location of the trainee's haptic device, and haptic information is exchanged between the locations over a communications network.

6. The surgical training system of claim 5 in which visual information about the virtual environment is also communicated between the locations over the communications network, the training system including a latency compensation manager at least at one of the locations for reducing an apparent latency on the communications network to facilitate telehaptic interactions between the locations.

7. The surgical training system of claim 1 including a trainer's visual interface for viewing a trainer's representation of the virtual environment and a trainee's visual interface for viewing a trainee's representation of the virtual environment, wherein the virtual model includes at least one virtual anatomical object that is visible in both the trainer's visual interface and the trainee's visual interface and wherein differing haptic characteristics are assigned to one or more areas adjacent the at least one anatomical object such that in at least one mode of operation varying force feedback is applied to at least the trainee's haptic device in dependence on a location of the virtual surgical tool respective to a boundary of the at least one anatomical object.

8. The surgical training system of claim 7 including a trainer's interface through which the trainer can adjust the haptic characteristics, including a geometric size, geometric shape and haptic feedback force magnitude, assigned to the one or more areas.

9. The surgical training system of claim 1 wherein the virtual model simulates laparoscopic surgery.

10. A method of training a trainee to perform surgery comprising:
displaying a virtual model of a surgical site;
providing a trainee haptic input device for use by the trainee to move a virtual surgical tool in the displayed virtual model;
receiving force feedback information in dependence on manipulations of an trainer input device used by a trainer at a remote location;
scaling the force feedback information based on a specified value; and
applying a scaled force feedback to the trainee through the trainee haptic input device in dependence on the scaled force feedback information.

11. The method of claim 10 comprising:
assigning a zone around an anatomical object displayed in the virtual model, the zone having a set of associated haptic characteristics;
accepting input from a trainer to dynamically adjust the haptic characteristics, including a geometric size, a geometric shape, and haptic feedback force magnitude, of the zone while training a trainee; and
varying the force feedback applied to the trainee through the trainee haptic input device in dependence on the relative location of the virtual surgical tool to the assigned zone and the associated haptic characters of the assigned zone.

12. A haptic enabled surgical training system, comprising:
a master device, including:
a master controller for controlling the operation of the master device,
a master display responsive to the controller for displaying a representation of a virtual surgical environment, a master electronic storage element coupled to the master controller and having stored thereon attributes for the virtual environment, the virtual surgical environment having regions, wherein each region is associated with a corresponding haptic response, and
a master haptic input device coupled to the controller for controlling a corresponding virtual surgical tool in the virtual environment; and
a slave device for communication with the master device via a network, having:
a slave controller for controlling the operation of the slave device, a slave display responsive to the slave controller for displaying the virtual surgical environment,
a slave electronic storage element coupled to the slave controller and having stored thereon attributes of the virtual surgical environment, and
a slave haptic input device coupled to the slave controller for controlling the virtual surgical tool in the virtual surgical environment and responsive to the haptic response associated with each region,
wherein, an input of the master haptic input device generates a master-to-slave corresponding haptic response onto the slave haptic input device.

13. The haptic enabled training system of claim 12, wherein in at least one operational mode an input of the slave haptic input device generates a slave-to-master corresponding haptic response onto the master haptic input device.

14. The haptic enabled training system of claim 12, wherein communication between the master device and the slave device is facilitated via a latency management tool to reduce an apparent latency on the communications network.

15. The haptic enabled training system of claim 12, wherein the master device further comprises a master user interface for manipulating the corresponding haptic response associated with each region in the virtual surgical environment, and for manipulating the size and shape of the regions.

16. The haptic enabled training system of claim 12, wherein each region has a corresponding visual appearance representative of the haptic response associated with the region.

17. The haptic enabled training system of claim 12, wherein the master device is operable to manipulate a degree of force in the master-to-slave corresponding haptic response.

18. The haptic enabled training system of claim 12, wherein the master device is operable to enable and disable the master-to-slave corresponding haptic response.

19. The haptic enabled training system of claim 12, wherein at least one of the master device and the slave device is configured to collect haptic and other information about the operation of the system during a training session for subsequent analysis and review with a trainee.

20. A method of training a trainee to perform surgery comprising:
displaying a virtual model of a surgical site;
providing a trainee haptic input device for use by the trainee to move a virtual surgical tool in the displayed virtual model;
assigning a zone around an anatomical object displayed in the virtual mode, the zone having a set of associated haptic characteristics;
accepting input from a trainer to dynamically adjust the haptic characteristics, including a geometric size, a geometric shape, and haptic feedback force magnitude, of the zone while training a trainee; and
varying the force feedback applied to the trainee through the trainee haptic input device in dependence on the relative location of the virtual surgical tool to the assigned zone and the associated haptic characters of the assigned zone.

21. A method of training a trainee to perform surgery at a trainee station that includes a trainee haptic input device comprising:
displaying at the trainee station a virtual model of a surgical site;
receiving visual and haptic information over a communications network;
applying latency compensation to the at least the haptic information; and
applying force feedback to the trainee haptic input device in dependance on the compensated haptic information and modifying the displayed virtual model in dependence on the visual information.
